(19) United States
(12) Patent Application Publication
(10) Pub. No.: US 2009/0240414 A1
(43) Pub. Date: Sep. 24, 2009

(54) BRAKE NOISE SUPPRESSION VIA SYSTEM PRESSURE MODULATION

(75) Inventors: Omar S. Dessouki, Beverly Hills, MI (US); Brent D. Lowe, Milford, MI (US); Mark T. Riefe, Brighton, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/052,292

(22) Filed: Mar. 20, 2008

(51) Int. Cl. G06F 17/00; B60T 1/06; B60T 8/00

(52) U.S. Cl. 701/78; 188/2 R

(57) ABSTRACT

A method of brake noise suppression via brake system pressure modulation is disclosed that includes detecting a brake apply and modulating a brake system pressure to disrupt formation of a friction instability upon detection of the brake apply. The brake system pressure can be modulated at each brake apply detected, only when the brake apply detected is of a brake apply type that is indicative of brake noise, or when the system actually detects brake noise. Further, the system can determine whether a brake apply is associated with a noise-inducing friction instability; and modulate the brake system pressure to disrupt formation of the noise-inducting friction instability by hindering development of the limit cycle associated with the noise-inducing friction instability.

### TECHNICAL FIELD

This invention relates generally to vehicle braking systems and, more particularly, to suppression of brake noise via brake system pressure modulation.

### BACKGROUND OF THE INVENTION

Brake noise is a result of the excitation of a brake corner component, e.g. a brake rotor, a brake drum, a caliper bracket, etc., by the friction material. This phenomenon is also known as friction-induced vibration or friction instability, the onset of which is typically attributed to an increase in the friction between a brake pad and a brake rotor under a certain set of conditions, e.g. low ambient temperatures, light brake applies, high humidity, etc. The energy from the friction instability is dissipated through the brake corner component, in the form of a squeal, or through a chassis component, in the form of a groan.

One known technique of brake noise suppression includes a brake system that detects an ideal squeal condition and, if certain conditions are met during a brake apply, partially relieves the brake system pressure and then reapplies the brake system pressure as a one-time occurrence. Further, if the ideal squeal conditions are met in an off-brake condition, this known technique lightly activates the brake so as to minimize the possibility of the onset of stick/slip.

Other known techniques of brake noise suppression attempt to suppress brake squeal via control of the friction forcing function using piezoelectric stacks, e.g. dither control, or closed-loop hydraulic pressure control to avoid particular conditions that can cause brake squeal.

Further, other known techniques of brake noise suppression include physical modifications of the brake system, e.g. the addition of lining chamfers and/or pad shims, or the use of low coefficient friction linings and/or damped iron rotors, which can be costly and represent some measure of additional risk to implement.

### SUMMARY OF THE INVENTION

A method of brake noise suppression via brake system pressure modulation is disclosed including the steps of: detecting a brake apply and modulating a brake system pressure to disrupt formation of a friction instability upon detection of the brake apply.

In one example embodiment, the brake system pressure is modulated at each brake apply detected.

In another example embodiment, the method further includes the steps of: determining whether the brake apply detected is of a brake apply type that is indicative of brake noise; and modulating the brake system pressure to disrupt formation of the friction instability only when the brake apply type is indicative of brake noise, for example but not limited to, light brake applies, low vehicle speeds and/or low ambient temperature.

In yet another example embodiment, the method further includes the steps of: identifying a limit cycle associated with a noise-inducing friction instability; determining whether the brake apply is associated with a noise-inducing friction instability; and modulating the brake system pressure to disrupt formation of the noise-inducing friction instability by hindering development of the limit cycle associated with the noise-inducing friction instability.

In yet another example embodiment, the method further includes the steps of: detecting a brake noise; and modulating the brake system pressure only upon detection of the brake noise.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of an example hydraulic braking system for a vehicle, including brake noise suppression via pressure modulation according to the present invention;

FIG. 2A is a schematic illustration of an example hybrid electro-hydraulic braking system for a vehicle, including brake noise suppression via pressure modulation according to the present invention;

FIG. 2B is a schematic illustration of an example electric braking system for a vehicle, including brake suppression via pressure modulation according to the present invention;

FIG. 3A is a flowchart illustrating one embodiment of brake noise suppression via system pressure modulation according to the present invention;

FIG. 3B is a flowchart illustrating another embodiment of brake noise suppression via system pressure modulation according to the present invention;

FIG. 3C is a flowchart illustrating yet another embodiment of brake noise suppression via system pressure modulation according to the present invention; and

FIG. 3D is a flowchart illustrating yet another embodiment of brake noise suppression via system pressure modulation according to the present invention.

### DESCRIPTION OF THE PREFERRED EMBODIMENTS

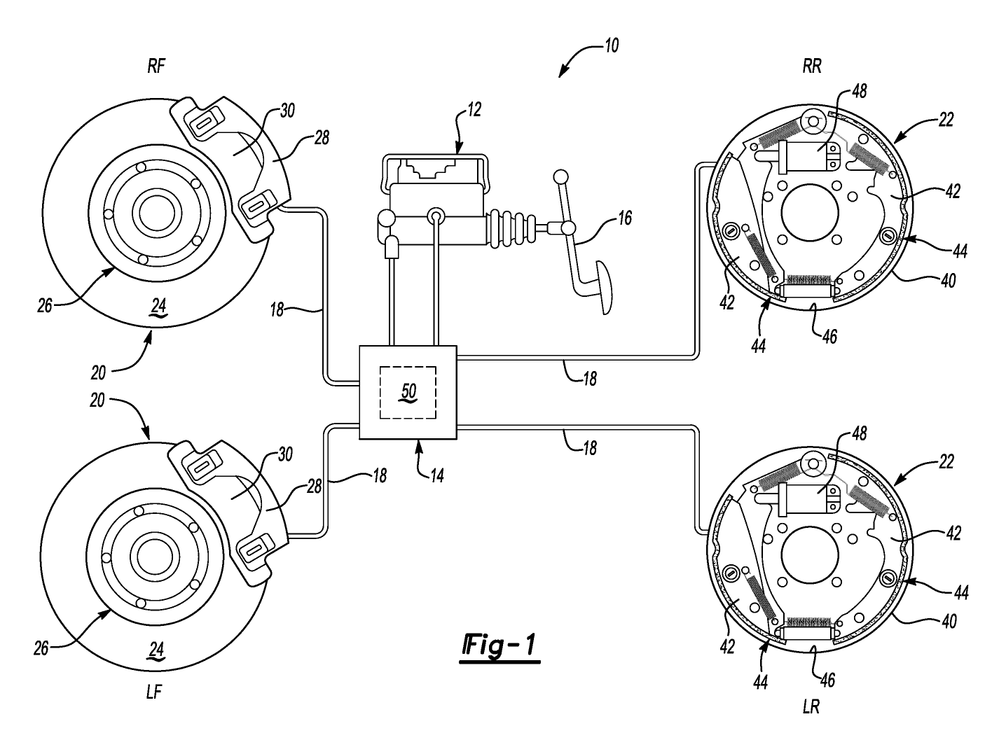

Referring to the drawings, wherein like reference numbers refer to like components, FIG. 1 is a schematic illustration of an example hydraulic braking system for a vehicle is indicated generally at 10. The example hydraulic braking system 10 includes a master cylinder 12 in fluid communication with a hydraulic brake unit or anti-lock brake (ABS) modulator 14. The master cylinder 12 is operable to receive an input from a brake pedal 16, which is indicative of a brake apply.

As a driver (not shown) exerts pressure on the brake pedal 16, hydraulic pressure within the master cylinder 12 increases. The hydraulic brake unit or ABS modulator 14 sends the hydraulic pressure through brake lines 18 to wheels RF, LF, RR, and LR located at each of the four corners of the vehicle.

Each of the two front wheels, RF and LF, of the vehicle are equipped with disk brake systems 20. Each of the two rear wheels, RR and LR, of the vehicle are equipped with drum brake systems 22.

Each of the two front disk brake systems 20 includes a brake rotor or disk 24 mounted to a hub 26. A caliper 28 includes brake pads 30, which interact with the brake rotor 24 to cause the rotation of wheels RF and LF to slow and/or eventually stop. Each of the calipers 28 engages and/or disengages their respective brake pads 30, exerting and/or relieving an applied braking force, based on a change in the hydraulic pressure received through brake lines 18.

Each of the two rear drum brake systems 22 includes a brake drum 40 and a pair of brake shoes 42. A brake pad 44 is mounted to each of the brake shoes 42 and the brake pads 44 interact with an inner surface 46 of each of the brake drums 40 to cause the rotation of wheels RR and LR to slow and/or eventually stop. A hydraulic brake cylinder 48 is operable to receive the hydraulic pressure from the brake lines 18 and to deliver hydraulic pressure to each of the brake shoes 42.

In response, each of the brake shoes 42 engages and/or disengages their respective brake pads 44, exerting and/or relieving an applied brake force, based on a change in the hydraulic pressure received through the brake lines 18.

The hydraulic brake unit 14 includes a controller, shown generally as 50, which is operable to detect the brake apply received from the brake pedal 16 and to modulate the hydraulic pressure delivered through the brake lines 18 to each of the wheels RF, LF, RR and LR, to modulate the applied brake force.

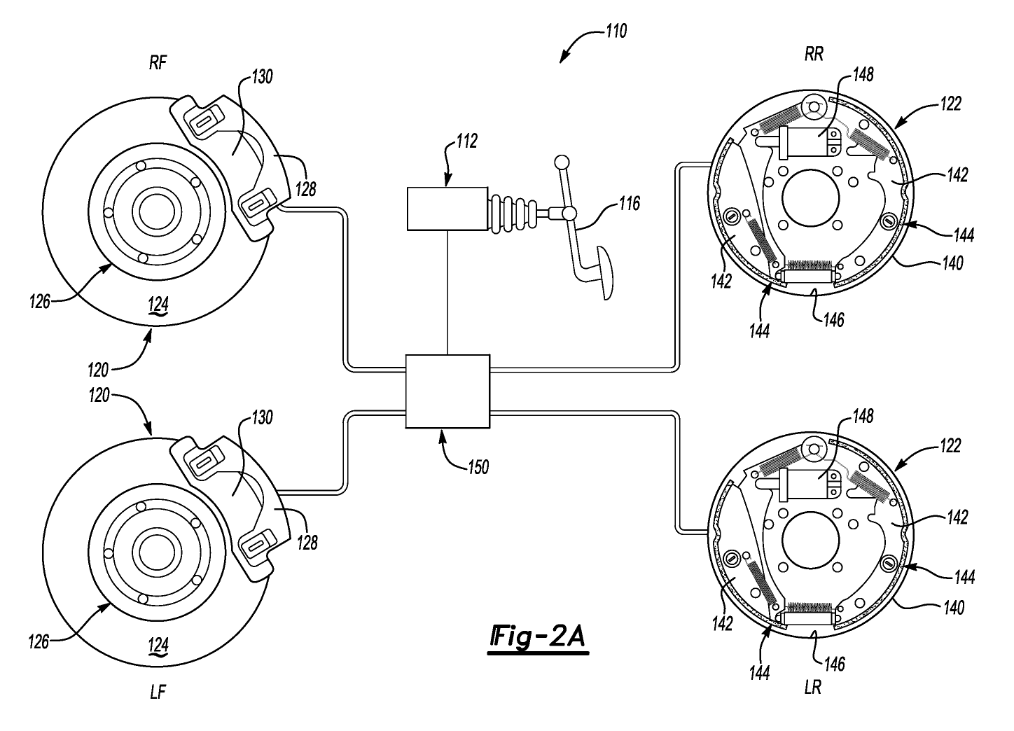

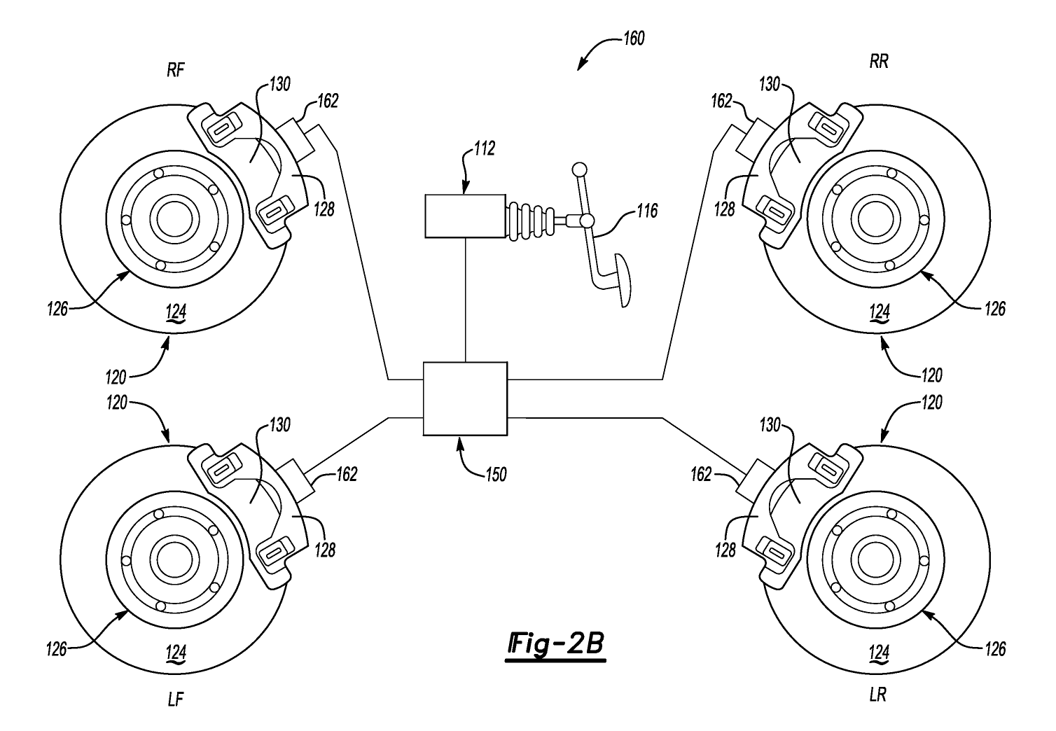

FIG. 2A is a schematic illustration of an example hybrid electro-hydraulic vehicle braking system, indicated generally at 1 10. The example hybrid electro-hydraulic braking system 110 includes a pedal emulator 112 in electronic communication with an electronic controller 150. The pedal emulator 112 is operable to receive an electronic input from a brake pedal 116, which is indicative of a brake apply, and to transfer the electronic input to the electronic controller 150.

As a driver (not shown) exerts pressure on the brake pedal 116, the electronic controller 150 is operable to transmit the electronic input to wheels RF, LF, RR, and LR located at each of the four corners of the vehicle.

Each of the two front wheels, RF and LF, of the vehicle are equipped with disk brake systems 120. Each of the two rear wheels, RR and LR, of the vehicle are equipped with drum brake systems 122.

Each of the two front disk brake systems 120 includes a brake rotor or disk 124 mounted to a hub 126. A caliper 128 includes brake pads 130, which interact with the brake rotor 124 to cause the rotation of wheels RF and LF to slow and/or eventually stop. Each of the calipers 128 engages and/or disengages their respective brake pads 130, exerting and/or relieving an applied braking force, based on the electronic input received from the electronic controller 150.

Each of the two rear drum brake systems 122 includes a brake drum 140 and a pair of brake shoes 142. A brake pad 144 is mounted to each of the brake shoes 142 and the brake pads 144 interact with an inner surface 146 of each of the brake drums 140 to cause the rotation of wheels RR and LR to slow and/or eventually stop. A hydraulic brake cylinder 148 is operable to receive the electronic input from the electronic controller 150 and to exert hydraulic pressure to each of the brake shoes 142.

In response, each of the brake shoes 142 engages and/or disengages their respective brake pads 144, exerting and/or relieving an applied brake force, based on the electronic input received from the electronic controller 150.

The electronic controller 150 is operable to detect the brake apply received from the brake pedal 116 and to modulate a hydraulic pressure at each of the wheels RF, LF, RR and LR, to modulate the applied brake force.

At each applied brake force interface, i.e. between the brake pads 30, 130 and the brake rotor 24, 124 and between the brake pads 44, 144 and the brake drums 40, 140, there exists an opportunity for brake noise, which is the excitation of a brake corner component, for example but not limited to, a brake rotor, a brake drum, a brake caliper bracket or the like, by the friction material, i.e. the brake pad. This phenomenon is known as friction-induced vibration or friction instability. The energy from the friction instability is dissipated through the brake rotor or the caliper bracket as brake noise, in the form of a groan.

FIG. 2B is a schematic illustration of an example electric vehicle braking system, indicated generally at 160. The example electric braking system 160 includes a pedal emulator 112 in electronic communication with an electronic controller 150 as previously illustrated in the example electro-hydraulic vehicle braking system 110 (FIG. 2A). The pedal emulator 112 is operable to receive an electronic input from a brake pedal 116, which is indicative of a brake apply, and to transfer the electronic input to the electronic controller 150.

As a driver (not shown) exerts pressure on the brake pedal 116, the electronic controller 150 is operable to transmit the electronic input to wheels RF, LF, RR, and LR located at each of the four corners of the vehicle.

Each of the two front wheels, RF and LF, and each of the two rear wheels RR and LR, of the vehicle are equipped with disk brake systems 120. Each of the disk brake systems 120 includes a brake rotor or disk 124 mounted to a hub 126. A caliper 128 includes brake pads 130, which interact with the brake rotor 124 to cause the rotation of wheels RF and LF to slow and/or eventually stop.

An electric motor 162 is mounted in electrical communication with each of the calipers 128 and the electronic controller 150. Each caliper 128 is operable to engage and/or disengage their respective brake pads 130, exerting and/or relieving an applied braking force, based on the electronic input received from the electronic controller 150.

The electronic controller 150 is operable to detect the brake apply received from the brake pedal 116 and to control each of the electric motors 162 located at each of the wheels RF, LF, RR and LR, to modulate the applied brake force.

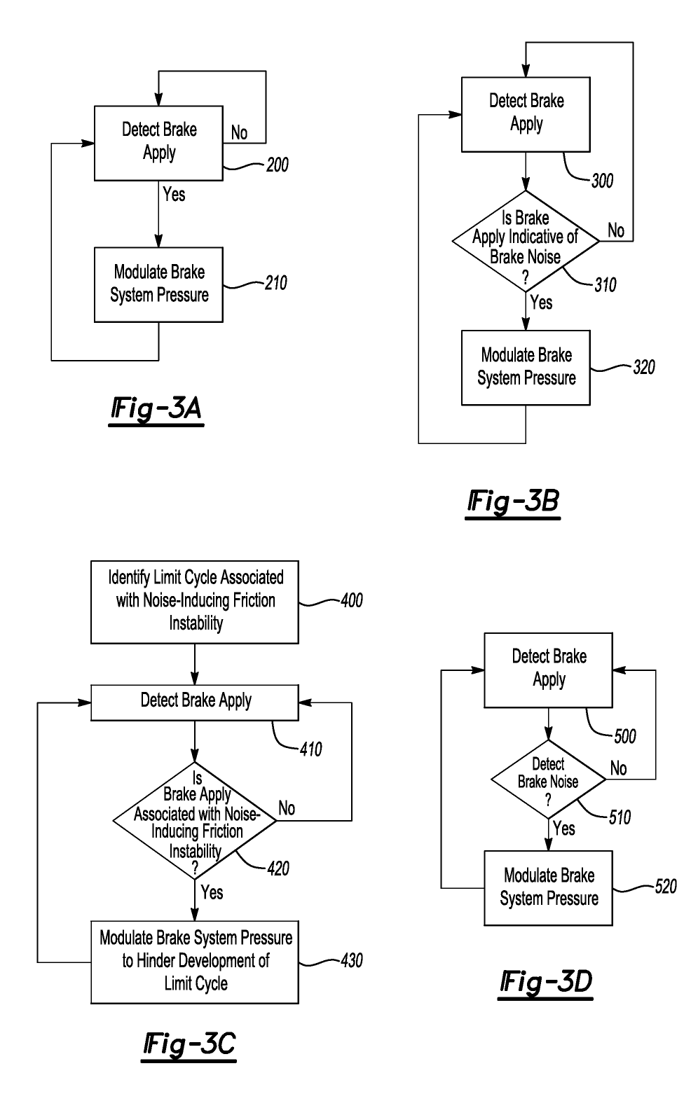

In one example embodiment, as illustrated in FIG. 3A, the controller 50, 150 is operable to: detect a brake apply 200; and modulate a brake system pressure 210 to disrupt formation of a friction instability upon detection of the brake apply, i.e. at each brake apply detected.

In another example embodiment, as illustrated in FIG. 3B, the controller 50, 150 is operable to: detect a brake apply 300; determine whether the brake apply detected is of a brake apply type that is indicative of brake noise 310; and modulate the brake system pressure to disrupt formation of the friction instability only when the brake apply type is indicative of brake noise 320, for example but not limited to, light brake applies, low vehicle speeds and/or low ambient temperature.

In yet another example embodiment, as illustrated in FIG. 3C, the controller 50, 150 is operable to: identify a limit cycle associated with a noise-inducing friction instability 400; detect a brake apply 410; determine whether the brake apply is associated with a noise-inducing friction instability 420; and modulate the brake system pressure to disrupt formation of the noise-inducting friction instability by hindering development of the limit cycle associated with the noise-inducing friction instability 430.

In yet another example embodiment, as illustrated in FIG. 3D, the controller 50, 150 is operable to: detect a brake apply 500; detect a brake noise 510; and modulate the brake system pressure only upon detection of the brake noise 520.

In each of the disclosed example embodiments discussed above, the brake system pressure modulation results in modulation of a normal force on the brake lining and the friction force, thereby disrupting the formation of friction instabilities. The modulation is of a small enough magnitude that the driver is unaware of any modulation.

Further, as discussed above, in the hydraulic braking system illustrated in FIG. 1, the brake system pressure is a hydraulic pressure controlled by the controller 50 associated with the hydraulic brake unit or ABS modulator 14. However, the hydraulic pressure may also be controlled by any other pressure modulating device.

Finally, as discussed above, in the electric braking system illustrated in FIG. 2, the brake system pressure is a hydraulic pressure controlled by the electronic control unit 150. However, the brake system pressure could also be an electronic clamping force exerted at each of the wheels RF, LF, RR and LR. As such, the electronic clamping force would be the brake system pressure that would be modulated. Further, the electronic clamping force could be exerted by, for example but not limited to, a motor located at each wheel.

While the best modes for carrying out the invention have been described in detail, those familiar with the art to which this invention relates will recognize various alternative designs and embodiments for practicing the invention within the scope of the appended claims.

1. A method of brake noise suppression comprising the steps of:
detecting a brake apply; and
modulating a brake system pressure to disrupt formation of a friction instability upon detection of the brake apply.

2. The method of brake noise suppression as recited in claim 1, wherein the brake system pressure is modulated at every brake apply detected.

3. The method of brake noise suppression as recited in claim 1, further including the steps of:
determining whether the brake apply detected is of a brake apply type that is indicative of brake noise; and
modulating the brake system pressure to disrupt formation of the friction instability only when the brake apply type is indicative of brake noise.

4. The method of brake noise suppression as recited in claim 3, wherein the brake apply type is a light brake apply that is indicative of brake noise.

5. The method of brake noise suppression as recited in claim 1, wherein the friction instability is a noise-inducing friction instability and further including the step of: identifying a limit cycle associated with the noise-inducing friction instability.

6. The method of brake noise suppression as recited in claim 5, wherein the brake system pressure is modulated to hinder development of the limit cycle associated with the noise-inducing friction instability.

7. The method of brake noise suppression as recited in claim 1, further including the step of: detecting a brake noise, wherein the brake system pressure is modulated only upon detection of the brake noise.

8. A vehicle braking system comprising:
at least one vehicle brake; and
at least one brake pressure modulator in communication with the at least one vehicle brake, wherein the at least one brake pressure modulator is operable to modulate a brake system pressure to disrupt formation of a friction instability upon detection of the brake apply.

9. The vehicle braking system as recited in claim 8, wherein the brake system pressure is modulated at every brake apply detected.

10. The vehicle braking system as recited in claim 8, wherein the brake system pressure is modulated only under brake applies indicative of brake noise.

11. The vehicle braking system as recited in claim 10, wherein a light brake apply is indicative of brake noise.

12. The vehicle braking system as recited in claim 8, wherein the friction instability is a noise-inducing friction instability.

13. The vehicle braking system as recited in claim 12, wherein the brake system pressure is modulated to hinder development of a limit cycle associated with the noise-inducing friction instability.

14. The vehicle braking system as recited in claim 8, wherein the brake system pressure is modulated only upon detection of the brake noise.

15. The vehicle braking system as recited in claim 8, wherein the brake pressure modulator is a hydraulic brake unit that is in hydraulic communication with the at least one vehicle brake.

16. The vehicle braking system as recited in claim 15, wherein the hydraulic brake unit is operable to modulate a hydraulic pressure associated with the at least one vehicle brake.

17. The vehicle braking system as recited in claim 8, wherein the brake pressure modulator is an electronic controller and the at least one vehicle brake is at least one electronic vehicle brake, the electronic controller in electronic communication with the at least one electronic vehicle brake.

18. The vehicle braking system as recited in claim 17, wherein the electronic controller is operable to modulate a brake clamp force associated with the at least one electronic vehicle brake.

19. The vehicle braking system as recited in claim 18, further including a pedal emulator in communication with the electronic controller, wherein the pedal emulator sends a signal through the electronic controller to the at least one electronic brake to modulate the brake clamp force.
